(19) United States
(12) Patent Application Publication
(10) Pub. No.: US 2014/0096071 A1
(43) Pub. Date: Apr. 3, 2014

(54) DISPLAY SYSTEM, DISPLAY DEVICE, AND IMAGE FORMING DEVICE

(71) Applicant: Konica Minolta, Inc., Tokyo (JP)

(72) Inventor: Atsushi TOMITA, Toyohashi-shi (JP)

(73) Assignee: Konica Minolta, Inc., Tokyo (JP)

(21) Appl. No.: 14/036,983

(22) Filed: Sep. 25, 2013

(30) Foreign Application Priority Data
Oct. 3, 2012 (JP) 2012-221155

(51) Int. Cl. G06F 3/0485

(52) U.S. Cl. CPC G06F 3/0485
USPC 715/784

(57) ABSTRACT

A display device for controlling a display of a display device having a touch panel includes an update processing module. In a case where a display range displayed in the touch panel in the display screen, created from a predetermined amount of electronic information read from electronic information stored in a storage device, reaches the end of the display screen after moved in the scroll direction and in a case where an operation amount of the scroll operation is more than or equal to a threshold value, the updated processing module reads the predetermined amount of electronic information provided next in the scroll direction from the storage and updates the display of the touch panel.

This application is based on Japanese Patent Application No. 2012-221155 filed with the Japan Patent Office on Oct. 3, 2012, the entire content of which is hereby incorporated by reference.

### BACKGROUND OF THE INVENTION

1. Field of the Invention

The present invention relates to a display system, a display device, and an image forming device, and more particularly to a display system and a display device for controlling a display of a touch panel, as well as an image forming device including the display device.

2. Description of the Related Art

As for mobile terminals such as a mobile phone, and image forming devices such as an MFP (Multi-Functional Peripheral), the capacity of a mounted temporary storage device such as a random access memory (RAM) is limited in some cases, in view of power consumption, device size, and manufacturing cost.

Therefore, in a case where a fixed storage device such as a hard disk device provided such that the above device is incorporated as the display device or incorporated in another device serves as a first storage device, and the above temporary storage device serves as a second storage device, when electronic information stored in the first storage device is read and temporarily stored in the second storage device to be displayed, the whole electronic information stored in the first storage device cannot be stored in the second storage device in the above display device in some cases.

In this case, as for such a display device, a predetermined amount of the electronic information is stored in the second storage device and displayed. Thus, as for this display device, when the display reaches an end (front end or back end) of a display screen created from the predetermined amount of information after the display has been scrolled, the predetermined amount of information positioned next in a scroll direction is automatically read from the first storage device. Thus, the display is updated in the scroll direction.

However, in the case where the predetermined amount of electronic information is read from the first storage device and stored in the second storage device to update the display in the display device in this way, there is a problem that it takes time to update the display. Especially, in the case where the electronic information is read from the first storage device serving as the fixed storage device in which the display device is incorporated in the other device, there is a problem that it takes more time in some cases depending on a communication process and a load status of a communication line.

On the other hand, this display device has a touch panel and can be operated in a gesture called a flick or pan performed such that a finger is swept or slipped on the touch panel. This operation is intuitive and can improve operability, so that it is required to update the display quickly. For example, Japanese Laid-Open Patent Publication No. 2011-23005 discloses a technique to scroll electronic information displayed on a display by a gesture operation.

As for the gesture-operable display device, as a well-known technique, the electronic information is scrolled by the gesture operation such as a flick, and when the scroll reaches an end of the display screen of the electronic information, a key for further displaying the additional electronic information is displayed, and when the key is operated, the next electronic information is obtained and displayed.

However, according to the above technique, when the display screen is updated, it is necessary to switch the operation to a tap operation which is a different operation method from the gesture operation such as the flick. Therefore, there is a problem that continuity of the operation is damaged at the time of switching from the scroll in the gesture operation to the next display. In addition, there is a problem that since the scroll is needed to display the key for indicating the update of the display, a scroll amount is increased.

Furthermore, in a case where the user unintentionally instructs the device to further display a part beyond the end of the display screen by the gesture operation, the display device automatically reads the next information in the scrolling direction from the first storage device, so that there is a problem that the display is updated in some cases, despite the intention of the user. Therefore, there is a problem that the user cannot confirm the information provided at the end of the display screen, or it takes time to display the updated display screen.

### SUMMARY OF THE INVENTION

The present invention has been devised in view of the above problems, and it is an object of the present invention to provide a display system, a display device, and an image forming device capable of improving convenience of users, in a display system provided such that electronic information stored in a first storage device is read and stored in a second storage device, and a display is made in a touch panel based on the information stored in the second storage device.

In order to attain the above object, according to one aspect of the present invention, a display system includes an information processing device including a first storage device for storing electronic information, and a display device having a second storage device and a touch panel. The display device includes a temporary storage module for accessing the information processing device, reading a predetermined amount of electronic information from the electronic information stored in the first storage device, and temporarily storing the predetermined amount of electronic information in the second storage device, a storage module for storing a display screen created from the predetermined amount of electronic information stored temporarily, a detecting module for detecting a fact that a scroll operation for a display of the touch panel is performed on the touch panel, a scroll processing module for moving a display range displayed in the touch panel in the display screen, in a scroll direction instructed by the scroll operation and displaying the display range in the touch panel, in a case where the display range does not reach an end of the display screen even after moved in the scroll direction, and an update processing module for accessing the information processing device, reading the predetermined amount of electronic information provided next in the scroll direction from the first storage device, storing the next predetermined amount of electronic information in the second storage device, and updating the display of the touch panel to a display screen created from the next predetermined amount of electronic information, in a case where the display range reaches the end of the display screen after moved in the scroll direction by a predetermined amount, and in a case where an operation amount of the scroll operation is more than or equal to a threshold value.

According to another aspect of the present invention, a display device is a display device having a touch panel and includes a temporary storage module for reading a predetermined amount of electronic information from electronic information stored in a first storage device, and temporarily storing the predetermined amount of electronic information in a second storage device, a storage module for storing a display screen created from the predetermined amount of electronic information, a detecting module for detecting a fact that a scroll operation for a display of the touch panel is performed on the touch panel, a scroll processing module for moving a display range displayed in the touch panel in the display screen, in a scroll direction instructed by the Scroll operation and displaying the display range in the touch panel, in a case where the display range does not reach an end of the display screen even after moved in the scroll direction, and an update processing module for reading the predetermined amount of electronic information provided next in the scroll direction from the first storage device, storing the next predetermined amount of electronic information in the second storage device, and updating the display of the touch panel to a display screen created from the next predetermined amount of electronic information, in a case where the display range reaches the end of the display screen after moved in the scroll direction, and in a case where an operation amount of the scroll operation is more than or equal to a threshold value.

According to still another aspect of the present invention, an image forming device includes the above display device.

According to yet still another aspect of the present invention, a non-transitory computer-readable storage medium stores a display control program for causing a computer execute a process to control a display in a touch panel in a display screen created based on electronic information. The display control program causes the computer execute the steps of reading a predetermined amount of electronic information from electronic information stored in a first storage device, and temporarily storing the predetermined amount of electronic information in a second storage device, storing a display screen created from the predetermined amount of electronic information, specifying a display range corresponding to the touch panel in the display screen and displaying the display range in the touch panel, detecting a fact that a scroll operation for a display of the touch panel is performed on the touch panel, determining whether or not the display range displayed in the touch panel in the display screen reaches an end of the display screen after moved in a scroll direction indicated by the scroll operation, moving the display range in the scroll direction and displaying the display range in the touch panel, in a case where the display range does not reach the end of the display screen after moved in the scroll direction, and reading the predetermined amount of electronic information provided next in the scroll direction from the first storage device, temporarily storing the next predetermined amount of electronic information in the second storage device, and updating the display of the touch panel to a display screen created from the next predetermined amount of electronic information, in a case where the display range reaches the end of the display screen after moved in the scroll direction, and in a case where an operation amount of the scroll operation is more than or equal to a threshold value.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is view showing a concrete example of a configuration of an image forming system according to an embodiment.

FIG. 2 is a schematic view showing a schematic hardware configuration of an image forming device included in the image forming system.

FIG. 3 is a flowchart showing a flow of a whole process in the image forming device.

FIGS. 4 to 7 are views each showing a display example of a screen based on electronic information.

FIG. 8 is a view showing a scroll gesture.

FIG. 9 is a view showing a concrete example of a relationship between a gesture operation speed and a scroll speed.

FIGS. 10 to 12 are views showing a concrete example of a change in display according to the scroll gesture.

FIG. 13 is a view showing a concrete example of a shift of scroll speed in one scroll action.

FIG. 14 is a view showing a concrete example of a relationship between the scroll speed and a deformation amount.

FIG. 15 is a view showing a concrete example of a shift of a change in deformation amount in one deformation action.

FIG. 16 is a block diagram showing a concrete example of a functional configuration of the image forming device.

FIG. 17 is a flowchart showing a flow of a process of an operation panel in step S7 in FIG. 3.

FIG. 18 is a flowchart showing a flow of a deformation process in step S115 in FIG. 17.

FIG. 19 is a flowchart showing a flow of an update process in step S117 in FIG. 17.

FIG. 20 is a view for illustrating a relationship between a display screen and a display range before and after the display range reaches an end of the display screen in a touch panel.

### DESCRIPTION OF THE PREFERRED EMBODIMENTS

Hereinafter, an embodiment of the present invention will be described with reference to the drawings. In the following description, the same part or component is marked with the same reference sign. The name and function thereof are also the same. Therefore, the description thereof is not repeated.

In addition, in examples below, a control device for controlling a touch panel included in a display device is included in an image forming device. However, the control device may be a separate device connected to the image forming device, and control a display of an operation panel serving as the touch panel of the image forming device. That is, the touch panel included in the display device and the control device for controlling the display may be included in the different devices, and the display in the touch panel may be controlled by mutual communications therebetween.

In addition, the device including the display device having the touch panel is not limited to the image forming device and the display device may be included in any device.

### <System Configuration>

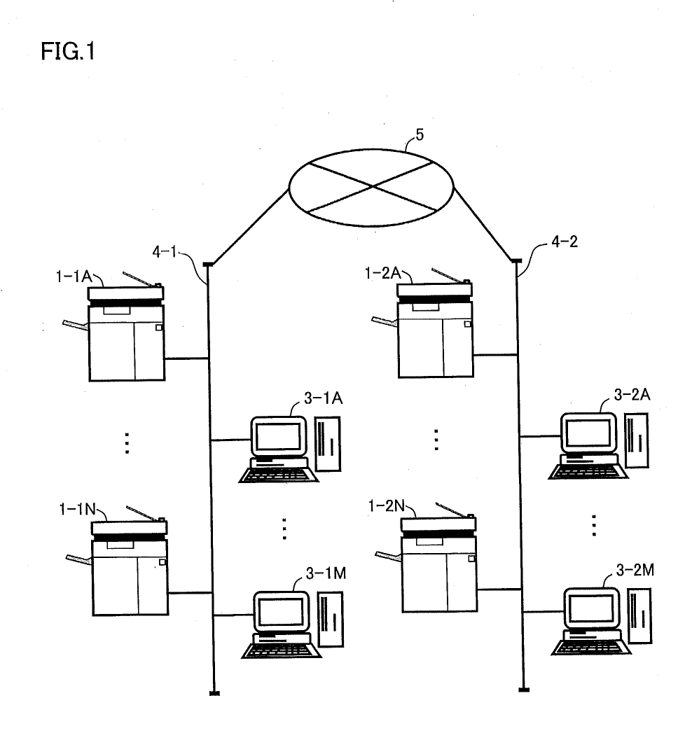

FIG. 1 is a view showing a concrete example of a configuration of an image forming system according to this embodiment. Referring to FIG. 1, the image forming system includes a first system having a plurality of image forming devices 1-1A, . . . 1-1N each including a display control device and a plurality of information processing devices 3-1A, . . . 3-1M connected to the plurality of image forming devices 1-1A, . . . 1-1N via a network 4-1, and a second system having a plurality of image forming devices 1-2A, . . . 1-2N and a plurality of information processing devices 3-2A, . . . 3-2M connected to the plurality of image forming devices 1-2A, . . . 1-2N via a network 4-2. The first system and the second system are connected via an external network 5.

Image forming devices 1-1A, . . . 1-1N, and 1-2A, . . . 1-2N are collectively referred to as an image forming device 1, and information processing devices 3-1A, . . . 3-1M, and 3-2A, . . . 3-2M are collectively referred to as an information processing device 3.

Network 4 may be any one of networks using a dedicated line such as a LAN (Local Area Network), networks using a general line such as the Internet, and networks using wireless communication. In addition, external network 5 may be also any one of networks using a dedicated line such as a LAN, networks using a general line such as the Internet, and networks using wireless communication. Furthermore, this image system may be connected to another system via external network 5.

According to this embodiment, image forming device 1 is a so-called MFP (Multi Functional Peripheral) having a function as a digital complex machine having functions of scanner, copier, and printer. However, image forming device 1 is not limited to the MFP, and may be another device such as scanner or copier as long as the device has a touch panel serving as an operation unit and a display unit.

Image forming device 1 forms a manuscript image obtained by scanning and a duplicated image created from print data sent from information processing device 3, on a sheet. Here, the print data is document data described by a draw command provided in a page description language which is obtained by converting a draw command from an operating system or an application program of information processing device 3, to the page description language by a printer driver so as to be processed by image forming device 1, or by a file format such as PDF (Portable Document Format), TIFF (Tagged Image File Format), JPEG (Joint Photographic Experts Group), or XPS (XML Paper Specification).

In addition, the manuscript image obtained by scanning may accept various settings (file format, layout setting, and resolution setting) in the image forming device, and may be transmitted to information processing device 3 or the like via network 4.

Information processing device 3 may be a general personal computer or the like. Information processing device 3 creates the print data in response to an instruction of a user, and transmits the created print data to image forming device 1.

### <Device Configuration>

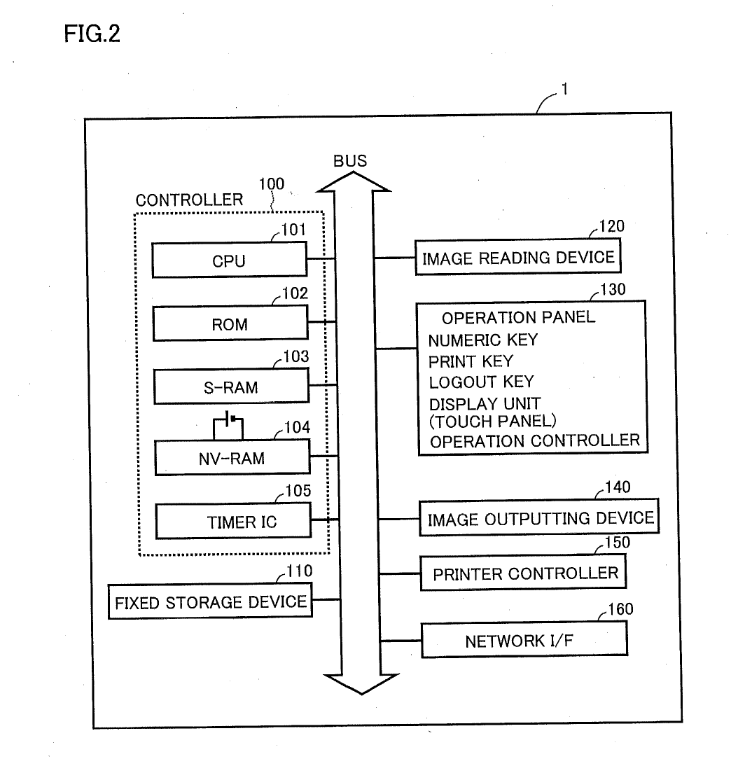

FIG. 2 is a schematic view showing a schematic hardware configuration of image forming device 1.

Referring to FIG. 2, image forming device 1 includes a controller 100, and controller 100 includes a CPU (Central Processing Unit) 101 for controlling the device as a whole, a ROM (Read Only Memory) 102 for storing a control program, a S-RAM (Static Random Access Memory) 103 serving as a storage region for actions, a battery backup NV-RAM (nonvolatile memory) 104 for storing various kinds of settings regarding the image formation, and a timer IC (Integrated Circuit) 105.

Controller 100 is connected via a bus to an image reading device 120, an operation panel 130 including a display unit serving as a touch panel having keys for performing various kinds of inputs and a display unit, a key switch group including numeric keys, a print key, and a logout key, and an operation controller, a network I/F (interface) 160 for transmitting and receiving various kinds of information with an external device such as information processing device 3 connected via networks 4-1, 4-2, and 5, a printer controller 150 for creating the duplicated image from the print data received through network I/F 160, and an image outputting device 140 for forming the duplicated image on the sheet.

In addition, controller 100 is connected to a fixed storage device 110 via the bus. Fixed storage device 110 corresponds to a hard disk device, for example.

### <Operation Outline>

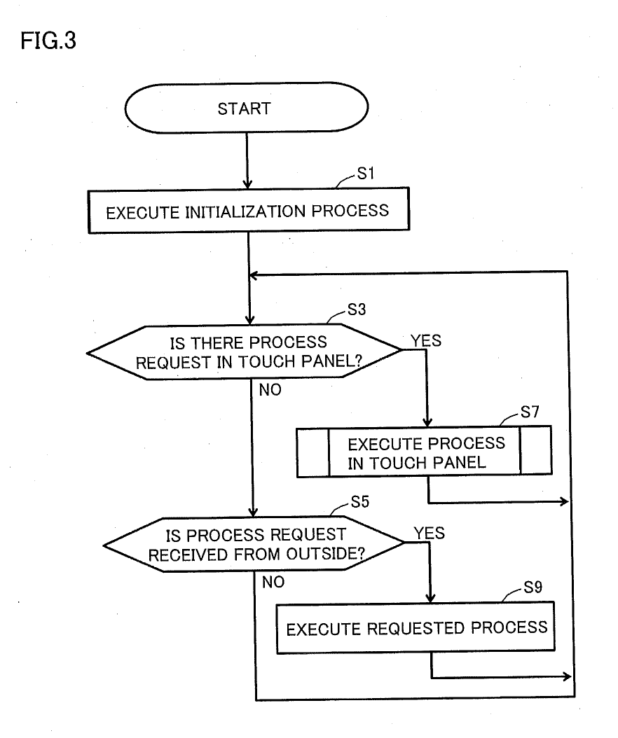

FIG. 3 is a flowchart showing a flow of an entire process in image forming device 1. The process shown in the flowchart in FIG. 3 is implemented such that CPU 101 in controller 100 reads a program stored in ROM 102, and develops and executes the program on S-RAM 103. The process shown in FIG. 3 is started when a power supply is turned on.

Referring to FIG. 3, when the process is started, CPU 101 executes an initializing process to clear a memory, set a standard mode, and the like (step S1).

After the initializing process, CPU 101 confirms whether or not the user requests some sort of process (copying process, various setting processes, display operation, or the like) requiring control of a display on the display unit serving as the touch panel, through the operation on the key switch group and the display unit serving as the touch panel provided on operation panel 130 of image forming device 1 (step S3). When there is no request (NO in step S3), CPU 101 proceeds to step S5.

Meanwhile, when the user requests the process (YES in step S3), CPU 101 performs a display process in the display unit serving as the touch panel of operation panel 130 (step S7). The process in the touch panel will be described below in detail.

When the user does not request the process (NO in step S3), CPU 101 confirms whether or not the external device such as information processing device 3 requests some sort of process (print process of a document, various setting processes, or the like) through networks 4-1, and 4-2 (step S5). When there is no request (NO in step S5), CPU 101 returns to step S3 and repeats the above processes.

When the external device requests some sort of process (YES in step S5), CPU 101 executes the requested process (step S9). Here, other processes correspond to a process of a print job transmitted from information processing device 3, a changing process for various settings stored in NV-RAM 104, and the like. After the process requested from the external device has been all completed, CPU 101 returns to step S3 and repeats the above processes.

Image forming device 1 displays a screen provided based on electronic information according to a user instruction, as the display process in the display unit serving as the touch panel of operation panel 130.

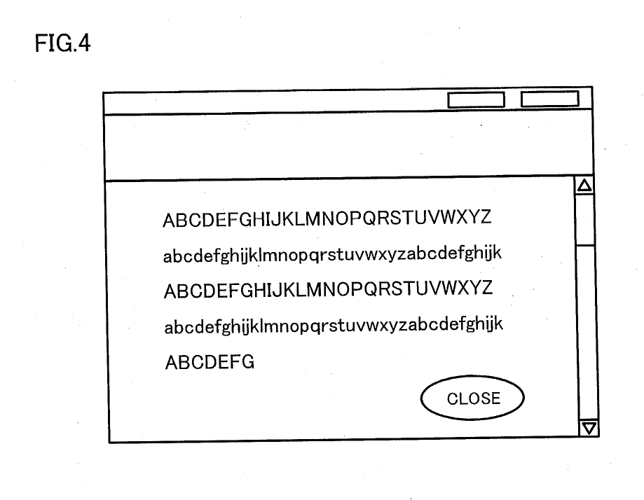

FIGS. 4 to 7 are views each showing a display example of the screen provided based on the electronic information.

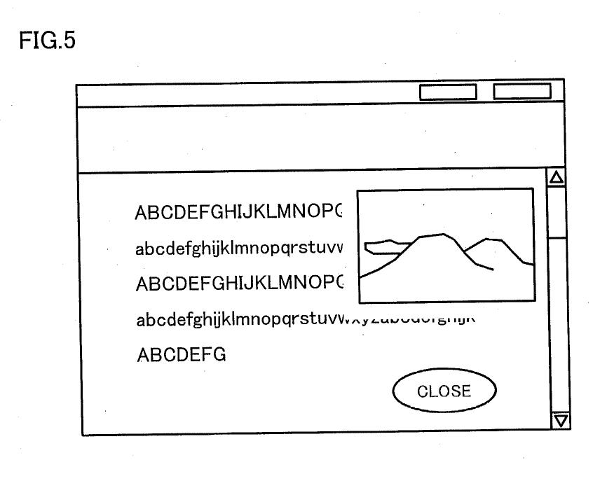

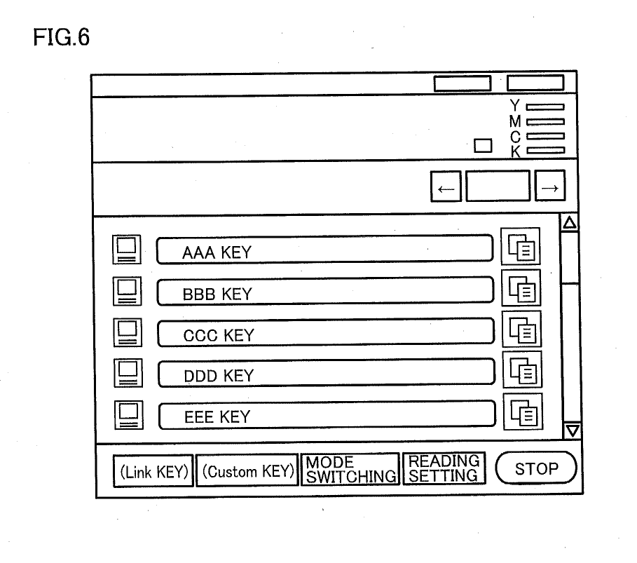

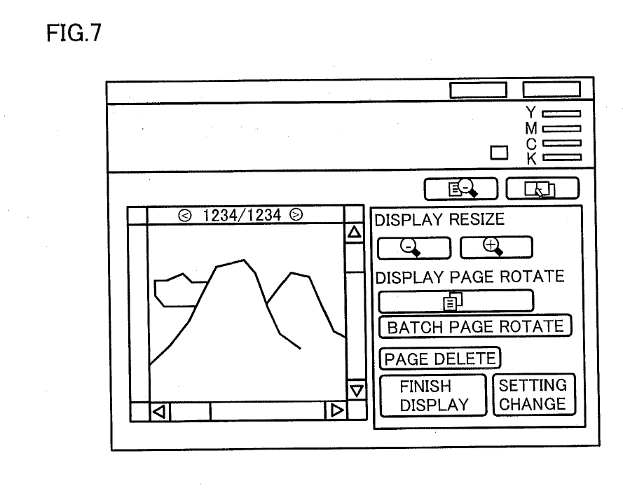

Here, the electronic information means data for creating a display screen of a document, a list of items, and an image. The display screen of the electronic information may have only a text as shown in FIG. 4, or may contain a display, an image, and a graph as well as the text as shown in FIG. 5. In addition, in the case of the display screen having information of the list of the items, the display screen may be a list form screen as shown in FIG. 6, or may have keys arranged so as to correspond to the items as shown in FIG. 7.

The electronic information is stored in fixed storage device 110 in image forming device 1, or in the fixed storage device in the external device such as information processing device 3. In displaying the electronic information, the image forming device reads the electronic information by a predetermined amount from fixed storage device 110 or the fixed device in the external device, and temporarily stores the read electronic information in the temporary storage device such as NV-RAM 104 to create the display screen. Thus, image forming device 1 specifies a range corresponding to a size of operation panel 130, in the display screen, as a display range, and displays the display screen within that range, on operation panel 130.

When image forming device 1 receives a scroll gesture which is a gesture operation to move the display range in step S3, under the condition that the display screen is partially displayed on operation panel 130, image forming device 1 executes a process to change the range to be displayed on operation panel 130 in the display screen, that is, executes a scroll action according to that operation, as the process on operation panel 130 in step S7. In addition, when image forming device 1 further receives the scroll gesture under the condition that the display range reaches an end of the display screen, image forming device 1 reads the predetermined amount of information positioned next to the position of the currently read electronic information in a scroll direction from fixed storage device 110 or the fixed storage device in the external device, and temporarily stores the electronic information in the temporary storage device to create a display screen.

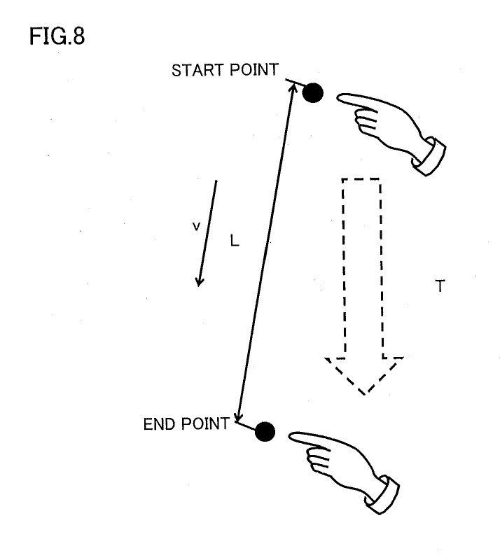

FIG. 8 is a view showing the scroll gesture.

Referring to FIG. 8, the scroll gesture is a gesture operation called a flick, that is, a gesture operation performed such that the user touches one point (start point) on operation panel 130 serving as the touch panel with a finger or the like, slides the finger by a distance L in a touched state, and releases the touched state by removing the finger from operation panel 130 at one different point (end point).

Image forming device 1 obtains a gesture operation speed v (v=L/T) by dividing travel distance L by an operation time T corresponding to a time from when the finger is touched until when the finger is removed. Thus, image forming device 1 scrolls the display range at scroll speed V previously defined with respect to gesture operation speed v.

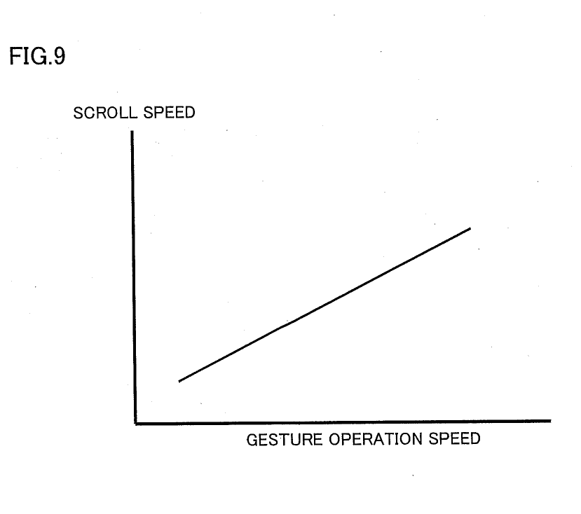

FIG. 9 is a view showing a concrete example of a relationship between the gesture operation speed and the scroll speed. For example, as shown in FIG. 9, scroll speed V may be defined such that scroll speed V is proportional to gesture operation speed v (V=k×v).

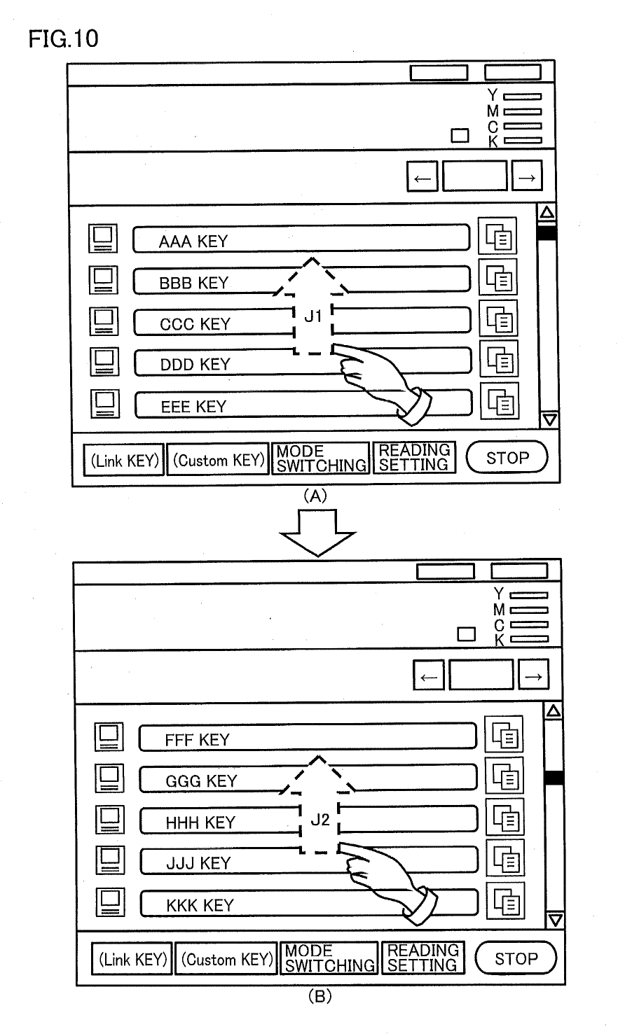

FIGS. 10, 11, and 12 are views each showing a concrete example of a change in display according to the scroll gesture, and as the concrete example, the change in display is shown in a case where a list of items is displayed. At this time, preferably, a scroll bar showing a position of the current display range in the display screen is displayed together with the display of the list of the items. Thus, the position in the display range can be visually known.

In addition, FIGS. 10, 11, and 12 each shows the example in which the flick is performed upward as the scroll gesture. At this time, the display range in the display screen is moved downward, that is, the display on operation panel 130 is scrolled downward.

Referring to FIG. 10, when a flick J1 is performed upward while the list of the items is displayed (FIG. 10(A)), image forming device 1 calculates gesture operation speed v from distance L and time T of flick J1, and further calculates scroll speed V from gesture operation speed v. According to the example in FIG. 9, the scroll speed is calculated by multiplying gesture operation speed v by a previously stored coefficient (V=k×v).

At this time, after image forming device 1 has scrolled the display range by a predetermined distance previously defined as a travel distance for one scroll action, image forming device 1 confirms whether or not the display range reaches the end of the display screen created from the electronic information. The predetermined distance corresponds to one line in the case where the display screen is the text, one item in the case where the display screen is the list of the items, and 10 pixl in the case where the display screen is the image.

For example, when image forming device 1 receives the gesture operation to scroll downward, image forming device 1 scrolls the display range downward by the predetermined distance, and confirms whether or not a lower end of the display screen is reached. When image forming device 1 receives the gesture operation to scroll upward, image forming device 1 confirms whether or not an upper end of the display screen is reached similarly. Thus, when the end is not reached, image forming device 1 scrolls the display according to the gesture operation.

According to the example in FIG. 10(A), since the display range is positioned very high in the display screen, so that image forming device 1 determines that the lower end of the display screen is not reached even when scrolls the display downward. Therefore, image forming device 1 scrolls the predetermined distance downward at the calculated scroll speed (FIG. 10(B)). When a flick J2 is performed upward in the screen in FIG. 10(B), the downward scroll is performed similarly.

At this time, preferably, image forming device 1 changes the scroll speed during the one scroll action serving as the process on operation panel 130. More specifically, when the scroll is started, image forming device 1 increases the scroll speed until a maximum scroll speed, and after the maximum scroll speed, image forming device 1 gradually reduces the speed until the scroll speed reaches 0 (stops).

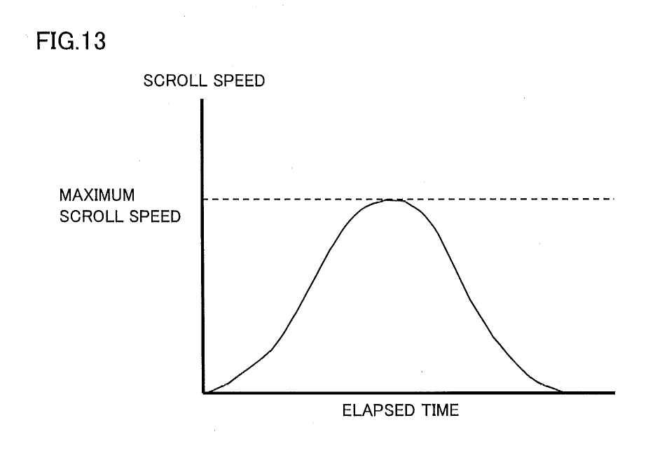

FIG. 13 is a view showing a concrete example of a shift of the scroll speed for one scroll action. As shown in FIG. 13, the scroll speed calculated from gesture operation speed v with reference to the relationship in FIG. 9, for example, is set as the maximum scroll speed, and image forming device 1 increases the scroll speed after the start of the scroll action to the maximum scroll speed, and reduces the scroll speed to zero.

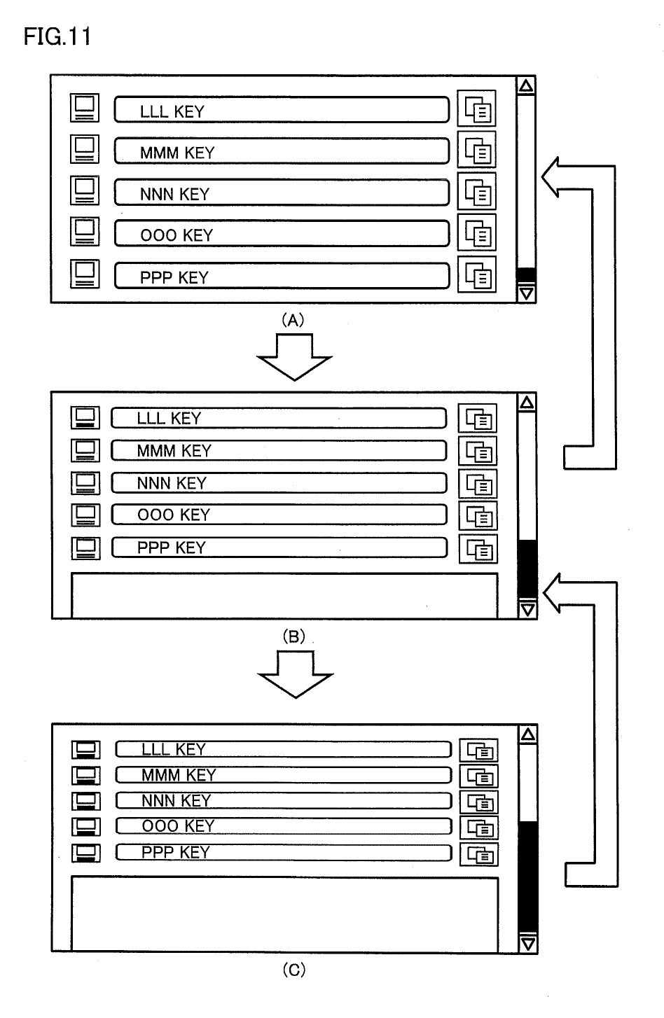

When the display range reaches the lower end of the screen after the downward scroll has been repeated, or when the downward flick is received under the condition that the display range is positioned at the lower end of the screen, image forming device 1 once displays the lower end of the display screen as the display range as shown in FIG. 11(A).

Then, image forming device 1 lifts the lower end of the display screen according to the above scroll speed. In association with the lift of the lower end, image forming device 1 increases a blank region showing an outer region of the display screen upward from the lower end of the display. At this time, while image forming device 1 keeps the display range in the display screen to the display range provided when the lower end of the display screen coincides with the lower end of the display as shown in FIG. 11(A), and keeps the display position of the upper end of the display range at the upper end of the display, image forming device 1 compresses (shrinks) the display of the display screen in the scroll direction (vertical direction) as the lower end of the display screen is lifted (FIG. 11(B)). According to examples shown in FIGS. 11(B) and 11(C), the display position of the upper end of the display range is kept at the upper end of the display, and five items are displayed as the list of the items.

After the start of the deformation, image forming device 1 increases a deformation amount of the display of the display screen in the scroll direction (vertical direction) to a previously defined maximum deformation amount (compression rate), within a previously defined time (FIG. 11(C)). Thus, the display screen is compressed to the maximum deformation amount (compression rate), and accordingly, the blank region is gradually increased.

In a case where gesture operation speed v of the downward flick is lower than a previously defined speed, it is determined that the flick indicates that the scroll is performed until the end of the currently displayed display screen, and does not indicate that the predetermined amount of information provided beyond the current electronic information is read and the display screen is updated. In this case, image forming device 1 gradually reduces the deformation amount of the display screen from the maximum in FIG. 11(C), and changes the screen as shown in FIG. 11(A) having the deformation amount of zero through the state in FIG. 11(B). Accordingly, the blank region is gradually reduced to zero.

In addition, at this time, preferably, CPU 101 does not apply the deformation amount to objects such as character or symbol in the display range and does not deform the objects. Thus, even when the display is deformed so as to be compressed or enlarged, readability of the user can be ensured. In addition, this deformation method may be performed in accordance with modification examples which will be described below.

The deformation amount (compression rate) is calculated from the scroll speed. Since scroll speed V is calculated from gesture operation speed v, it can be said that the deformation amount is also calculated from gesture operation speed v. That is, a deformation amount M can be expressed as a function of gesture operation speed v (M=f(v)).

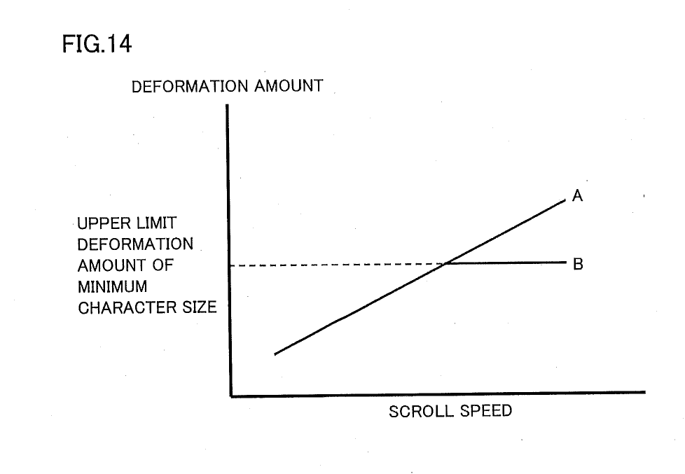

FIG. 14 is a view showing a concrete example of a relationship between the scroll speed and the deformation amount. For example, as shown in FIG. 14, deformation amount M may be defined so as to be proportional to scroll speed V (M=a×V). In this case, image forming device 1 calculates the deformation amount from the scroll speed calculated from the gesture operation speed.

The deformation amount in one deformation action changes with elapsed time. That is, a change rate y of the deformation amount can be expressed as a function of an elapsed time t from the deformation start (y=G(t)).

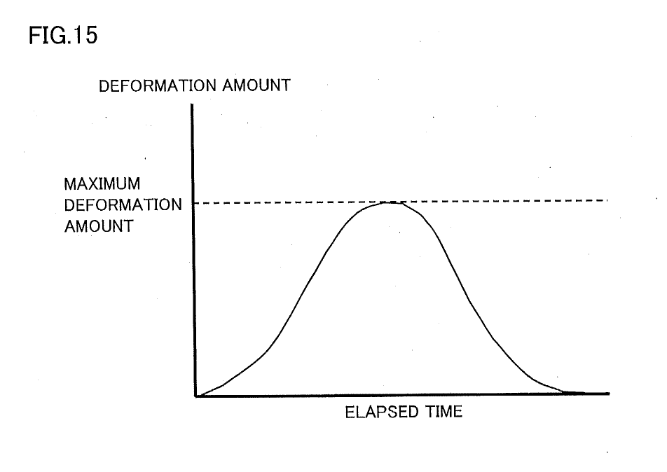

FIG. 15 is a view showing a concrete example of a shift of a change of the deformation amount in the one deformation action. As shown in FIG. 15, the deformation amount calculated from the scroll speed with reference to the relationship in FIG. 14, for example, is set as the maximum deformation amount, and image forming device 1 increases the deformation amount from the deformation start to the maximum deformation amount, and then reduces the deformation amount until the deformation amount reaches zero, that is, the original state is returned.

In the case of deforming the display, image forming device 1 continues to change the image data in the display range provided when the lower end of the display screen is displayed as the lower end of the display, at change rate y shown in FIG. 15 in the scroll direction from a point where the deformation amount is zero to a point where the deformation amount is zero through a point of maximum deformation amount M, at a predetermined time interval. Thus, every time the deformation is made, the display is made on operation panel 130 with the upper end of the display range fixed to the upper end of the list. In addition, the blank region is displayed in a display region below the display screen.

Thus, when the display range reaches the lower end of the display screen due to the downward flick, and when gesture operation speed v is lower than the previously defined speed, that is, when the update of the display screen is not indicated, the display changes as sequentially shown in FIG. 11(A), FIG. 11(B), FIG. 11(C), FIG. 11(B), and FIG. 11(A).

At this time, preferably, image forming device 1 deforms the position of the scroll bar displayed with the list of the items in the current display range in the display screen, and a mark (knob) representing a ratio of the display range to the whole display screen, in accordance with the deformation amount, as shown in FIGS. 11(B) and 11(C). In this way, the user can know how the deformation is made visually.

Meanwhile, when gesture operation speed v of the downward flick corresponding to the operation amount of the scroll operation (gesture operation) at this time is higher than the previously defined speed (threshold value), it is determined that this flick indicates that after scrolling to the end of the currently displayed display screen, the next predetermined amount of information is read and the display screen is updated.

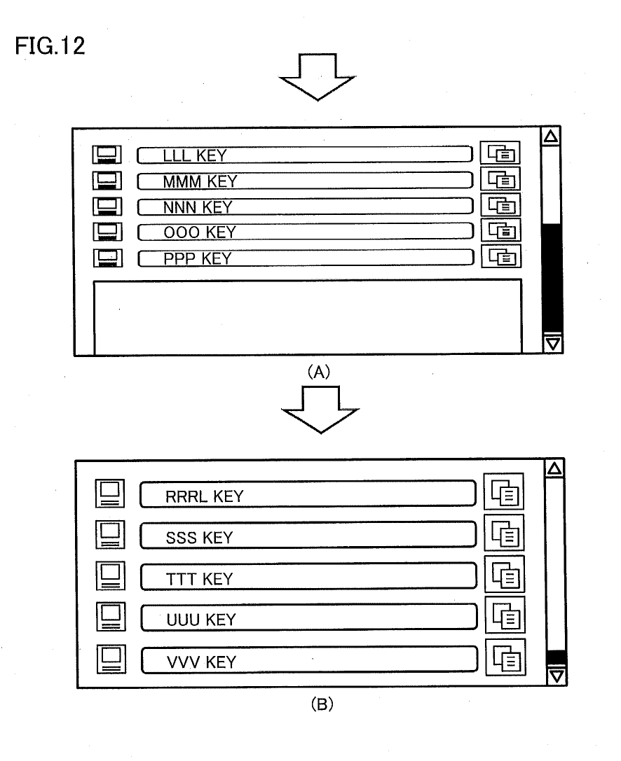

In this case, referring to FIG. 12, after deforming the current display range of the display screen to a state in FIG. 12(A) having the maximum deformation amount of the display screen similar to FIG. 11(C), image forming device 1 reads the predetermined amount of information provided next to the current electronic information in the scroll direction, and temporarily stores the electronic information in the temporary storage device to create a display screen. Then, image forming device 1 specifies a range from an end of the newly created display screen according to the size of operation panel 130, as a next display range, and displays the range on operation panel 130 as shown in FIG. 12(B). Thus, after the display screen has been compressed to the maximum deformation amount (compression rate), the display screen is switched to the next range of the display screen.

In addition, according to the examples shown in FIGS. 10 and 11, the flick is vertically made and the scroll is vertically performed, but the same is true for a horizontal direction.

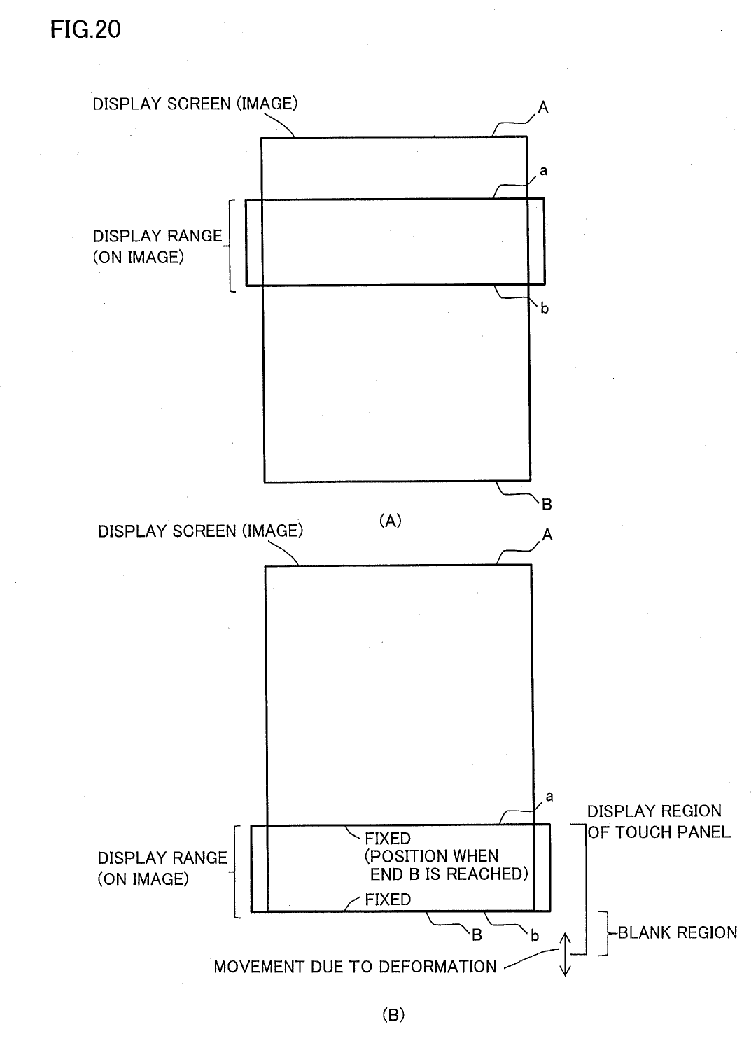

FIG. 20 is a view for describing a relationship between the display screen and the display range before and after the display range reaches the end of the display screen in the touch panel. FIG. 20(A) shows a state before the end of the display screen is reached, and FIG. 20(B) shows a state after the end of the display screen has been reached.

In addition, as shown in the figures, the “display screen” represents the image of the whole displaying data created based on the electronic information, and the “display range” represents the range displayed in the touch panel, in the displaying data. According to the examples in FIG. 20, a rectangle having a side A and a side B in the scroll direction as an upper end and a lower end thereof, respectively, represents the display screen serving as the image of the whole displaying data created from the electronic information, and a rectangle having a side a and a side b as an upper end and a lower end thereof, respectively, represents the display range in the touch panel.

Before reaching the end in FIG. 20(A), the display range sandwiched between side a and side b in the touch panel does not reach any end of the image of the whole displaying data sandwiched between side A and side B.

When the downward scroll is performed from the state in FIG. 20(A), the display range in the touch panel is moved downward in the display screen, and side b serving as the lower end of the display range reaches a position of side B serving as the lower end of the display screen as shown in FIG. 20(B). This state represents the state in which the display range in the touch panel reaches the lower end of the display screen. In a state in which the upper end is reached, side a serving as the upper end of the display range coincides with side A serving as the upper end of the display screen.

When the display range reaches the end of the display screen, the display in image forming device 1 sequentially deforms the image as sequentially shown in FIG. 11(A), FIG. 11(B), FIG. 11(C), FIG. 11(B), and FIG. 11(A). At this time, according to the example in FIG. 20(B) in which the scroll reaches the lower end of the display screen, as shown in the figure, side a serving as the upper end of the display range is fixed at a position of side a in the state provided when side b coincides with side B serving as the lower end of the display screen. Side b serving as the lower end of the display range is also fixed in the state provided when side b coincides with side B serving as the lower end of the display screen. Therefore, the display range is fixed in the display screen serving as the whole image as shown in FIG. 20(B).

Meanwhile, display contents in the display region of the touch panel change as the image displayed in the touch panel is deformed, as shown in FIG. 20(B). The “display region” here corresponds to a physical concept of the touch panel. That is, the display contents in the display region are increased as lower side b of the display range is gradually moved to the lower end side, and return to the original state. The blank region is provided in a part in which the display contents exceed the display screen in the display region.

In addition, although not shown, when the display range reaches the upper end of the display screen as a result of the scroll, this example is to be inversed.

### <Functional Structure>

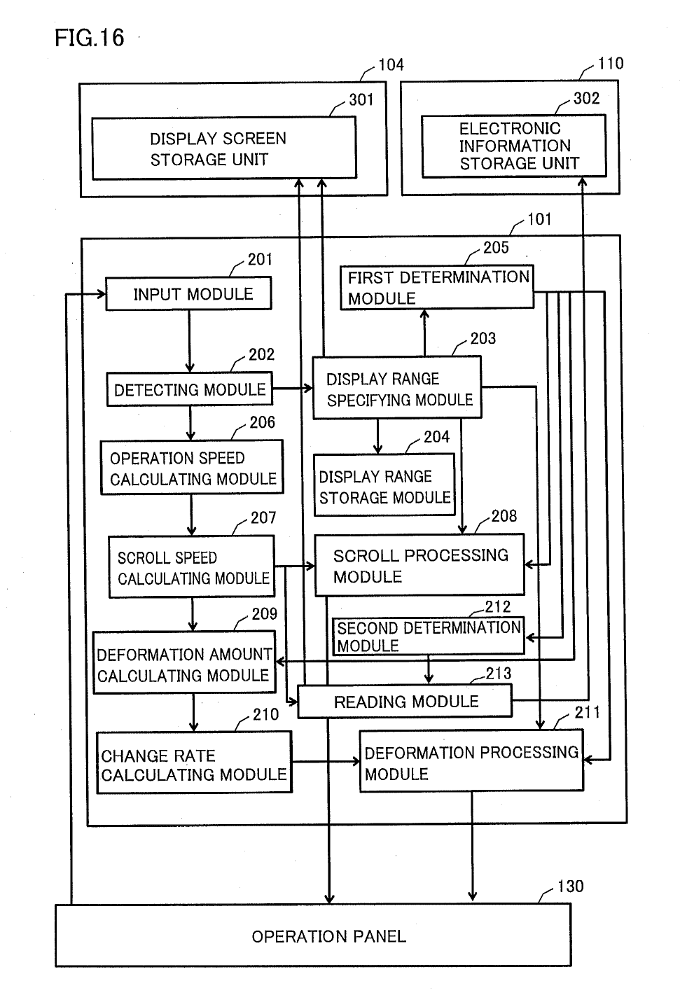

FIG. 16 is a block diagram showing a concrete example of a functional configuration of image forming device 1 to perform the above actions. Each function in FIG. 16 is a function mainly formed on CPU 101 in such a manner that CPU 101 reads a display control program stored in ROM 102, and develops and executes the display control program on S-RAM 103. However, at least one part may be implemented by a hardware configuration such as an electric circuit.

Referring to FIG. 16, a display screen storage unit 301 serving as a storage region to store the display screen based on the electronic information is provided in the temporary storage device such as NV-RAM 104. In addition, an electronic information storage unit 302 serving as a storage region to store the electronic information is provided in fixed storage device 110.

In addition, referring to FIG. 16, CPU 101 includes an input module 201 for receiving an instruction inputted when operation panel 130 serving as the touch panel is touched, a detecting module 202 for detecting a fact that the gesture operation on operation panel 130 is the scroll gesture such as the flick, a display range specifying module 203 for specifying the scroll direction based on the scroll gesture and specifying the display range in the display screen after the scroll, a display range storage module 204 for storing the display range, a first determination module 205 for determining whether or not the display range reaches the end of the display screen, an operation speed calculating module 206 for calculating gesture operation speed v (v=L/T) from the gesture operation serving as the scroll gesture, a scroll speed calculating module 207 for calculating the scroll speed from gesture operation speed v, a scroll processing module 208 for executing the scroll process as the process of operation panel 130, a deformation amount calculating module 209 for calculating deformation amount M from the scroll speed, a change rate calculating module 210 for calculating change rate y of the deformation amount during the predetermined time using deformation amount M as the maximum deformation amount, a deformation processing module 211 for performing the deformation process to deform the display while changing the deformation amount at change rate y using deformation amount M as the maximum deformation amount in the case where the display range reaches the end of the display screen after scrolling, a second determination module 212 for previously storing a threshold value of the gesture operation speed, and determining whether gesture operation speed v is higher or lower than the threshold value, that is, whether the operation is the operation to update the display screen, or the operation to indicate the scroll in the current display screen in the case where the display range reaches the end of the display screen after scrolling, and a reading module 213 for reading the predetermined amount of electronic information from fixed storage module 110 and store the display screen in display screen storage unit 301.

### <Operation Flow>

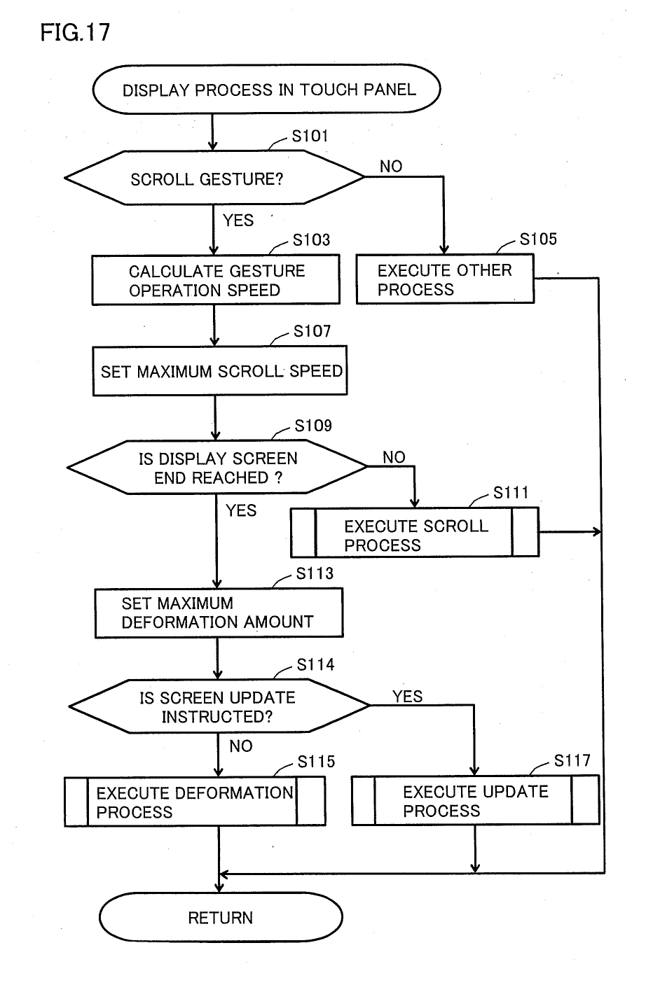

FIG. 17 is a flowchart showing a flow of the display process in the display unit serving as the touch panel of operation panel 130 in step S7. The actions shown in the flowchart in FIG. 17 are implemented such that CPU 101 reads the display control program stored in ROM 102, and develops and executes the display control program on S-RAM 103, to fulfill each function in FIG. 16.

Referring to FIG. 17, when the gesture operation showing the process request from the user is the scroll gesture (YES in step S101), CPU 101 calculates gesture operation speed v (v=L/T) by dividing travel distance L by operation time T corresponding to the time from the start to end of the finger touch (step S103). In addition, when the operation is not the scroll gesture, another process is performed according to the process request (step S105).

In addition, CPU 101 calculates the scroll speed from the gesture operation speed calculated in step S103, with reference to the previously stored relationship shown in FIG. 9, and sets the scroll speed as the maximum scroll speed (step S107).

Next, after scrolling the current display by the previously defined scroll amount, CPU 101 determines whether or not the end of the display screen is reached (step S109). Here, CPU 101 stores the scroll amount such as one line in the case where the display screen is text, one item in the case where the display screen is the list of the items, and 10 pixl in the case where the display screen is an image, as one scroll amount, and determines whether or not the display range reaches the end of the display screen after scrolling by the scroll amount depending on the display screen.

As a result of the scroll, when the display range does not reach the end of the display screen (NO in step S109), CPU 101 performs the scroll process (step S111). This scroll process is the normal scroll process. As one example, when the scroll starts, the display range is moved to update the display by the defined scroll amount, while the scroll speed is changed as shown in FIG. 12 until the scroll speed reaches zero through the maximum scroll speed set in step S107 within the previously defined time.

Meanwhile, as a result of the scroll, when it is determined that the display range reaches the end of the display screen (YES in step S109), CPU 101 calculates the deformation amount from the scroll speed calculated in step S107 (or gesture speed calculated in step S103), and sets the deformation amount as the maximum deformation amount (step S113).

CPU 101 previously stores the threshold value of the gesture operation speed, and determines whether gesture operation speed v of the scroll gesture is higher or lower than the threshold value, to determine whether the operation is the operation to update the display screen, or the operation to indicate the scroll in the current display screen. As a result, when gesture operation speed v is lower than the above threshold value, and the operation does not indicate the update of the display screen but indicates the scroll in the current display screen (NO in step S114), CPU 101 performs the deformation process using the deformation amount set in step S113 (step S115). Meanwhile, when gesture operation speed v is higher than the above threshold value, and the gesture operation does not indicates the scroll in the current display screen but indicates the update of the display screen (YES in step S114), CPU 101 executes the update process (step S117).

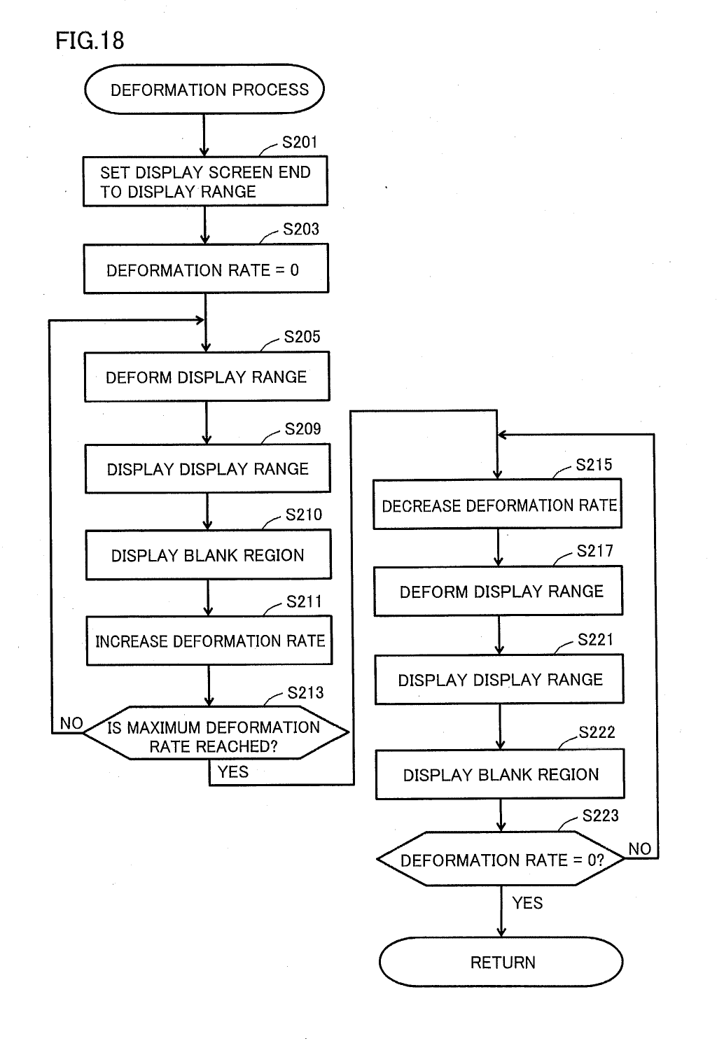

FIG. 18 is a flowchart showing a flow of the deformation process in step S115.

Referring to FIG. 18, CPU 101 sets the end of display screen reached as the result of the scroll, as the display range (step S201), and sets a deformation rate to zero at the time of the start of the deformation process (step S203). Then, CPU 101 deforms the image of the display range according to the deformation rate (=0) (step S205). Then, CPU 101 sets the display range from the deformed image (step S207), and displays the display range (step S209).

Since the deformation rate is zero at the time of the start of the deformation process, the end of the display screen is displayed on operation panel 130 as shown in FIG. 11(A) in this stage.

Then, CPU 101 increases the deformation rate with elapsed time as shown in FIG. 14 (step S211), and repeats steps S205 to S211 until the deformation rate reaches the maximum deformation rate set in step S113 (NO in step S213).

Thus, the display is compressed in the scroll direction from the start of the deformation process until the maximum deformation rate is reached as sequentially shown in FIG. 11(A), FIG. 11(B), and FIG. 11(C).

When the maximum deformation rate is reached (YES in step S213), CPU 101 reduces the deformation rate with the elapsed time as shown in FIG. 14 (step S215) until the deformation rate returns to zero (NO in step S223). Then, CPU 101 repeats the similar processes to those in steps S205 to S211 (steps S217 to S221).

Thus, after the maximum deformation rate has been reached, the compressed display is enlarged until the deformation rate returns to zero again as sequentially shown in FIG. 11(C), FIG. 11(B), and FIG. 11(A).

When the deformation rate reaches zero (YES in step S223), CPU 101 completes the series of processes.

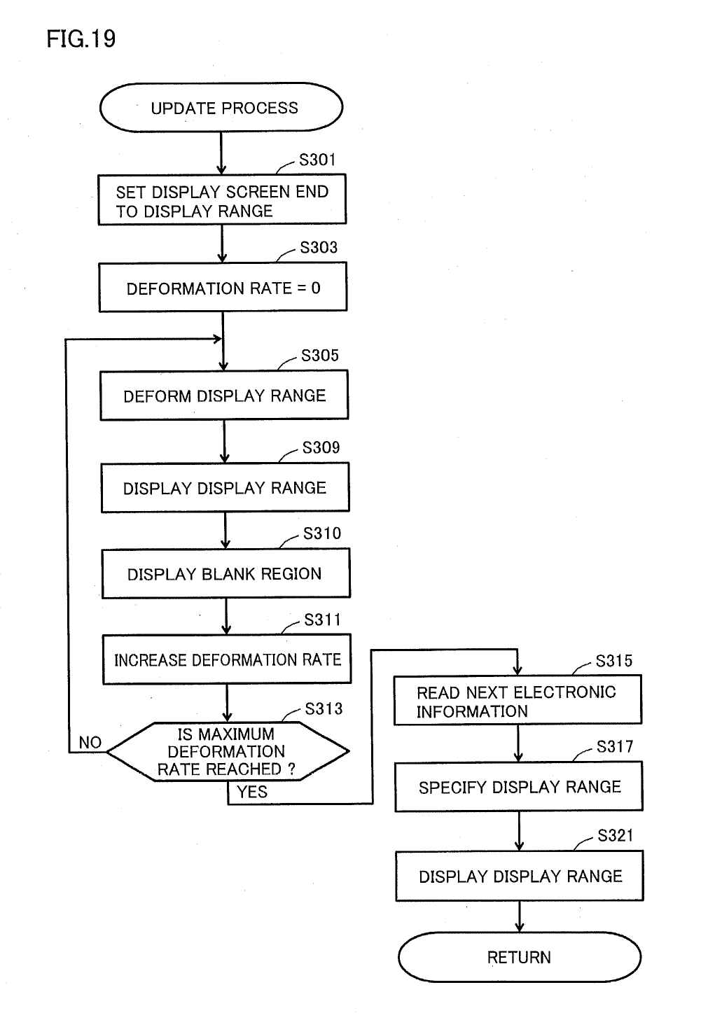

FIG. 19 is a flowchart showing a flow of the update process in step S117.

Referring to FIG. 19, CPU 101 fixes the end of the display screen reached by the scroll, to the display range and compresses the display until the maximum deformation rate is reached in steps S301 to S313, similar to steps S201 to S213 in FIG. 18.

Thus, the display is compressed in the scroll direction from the start of the update process until the maximum deformation rate is reached as sequentially shown in FIG. 11(A), FIG. 11(B), and FIG. 11(C).

When the maximum deformation rate is reached (YES in step S313), CPU 101 reads the next electronic information in the scroll direction of the current display screen from fixed storage device 110 (step S315), and specifies the display range in the display screen (step S317). Then, CPU 101 displays the specified display range on operation panel 130 (step S321).

Thus, as shown in FIG. 12, the screen is updated at once from the most compressed state in FIG. 12(A) similar to FIG. 11(C), to the next screen in FIG. 12(B).

### Effect of Embodiment

By performing the above actions in this system, in the process to read predetermined amount of electronic information stored in the fixed storage device of image forming device 1 or information processing device 3 serving as the external device by image forming device 1, and temporarily store the electronic information in the temporary storage device to create the display screen, and display the display screen with respect to each display size, it is possible to prevent the problem that when the scroll of the screen is instructed with the gesture operation, the end of the display screen is reached and the next electronic information is read and the screen is updated unintentionally.

### Modification Example 1

CPU 101 of image forming device 1 may change the threshold value of gesture operation speed v used to determine whether the gesture operation is the instruction to update the display screen, or the instruction to scroll in the current display screen, according to the number of times the electronic information is read and the screen is updated.

In order to perform this action, CPU 101 counts the number of updates of the screen, that is, the number of times the electronic information next to the same electronic information is read. CPU 101 may previously store a correspondence between the number of times the information is read and the above threshold value, and set the threshold value according to the counted number.

For example, CPU 101 may decrease the above threshold value as the number of times the screen is updated with respect to the same electronic information is increased. Thus, in the case of the display method in which the screen update is performed many times, the screen update is performed even when the operation speed of the gesture speed is low, so that operability can be improved.

In addition, for example, CPU 101 may increase the threshold value as the number of times the screen is updated with respect to the same electronic information is increased. Thus, in the case of the display method in which the screen update is performed many times, the unintentional screen display can be further prevented.

### Modification Example 2

In addition, CPU 101 of image forming device 1 may change the threshold value of gesture operation speed v used to determine whether the gesture operation is the instruction to update the display screen, or the instruction to scroll in the current display screen, according to a time required to read the electronic information.

In order to perform this action, in the case where CPU 101 reads the electronic information from the fixed storage device incorporated in itself, CPU 101 previously measures and stores a time required for the reading. Alternatively, in the case where CPU 101 reads the electronic information from the fixed storage device of the external device such as information processing device 3, a time required for the reading is measured and stored. This measurement may be made every time the reading is performed, and the average value may be used, or the measurement may be made defined number of times from the first reading, and the average value may be used. Thus, CPU 101 may previously store the correspondence between the time required for the reading and the threshold value, and set the threshold value according to the time required for the reading.

For example, CPU 101 may decrease the threshold value as the time required for reading the electronic information is decreased. Thus, operation efficiency can be enhanced.

### Modification Example 3

In addition, in the above examples, CPU 101 uses operation speed V serving as the operation amount of the gesture operation, as the threshold value, but may use another operation amount (parameter). The other parameters may be travel distance L of the gesture operation, acceleration, or combination of these. In this case also, the operability can be similarly enhanced.

Furthermore, it is possible to provide a program to cause CPU 101 of image forming device 1 execute the above actions to function as a control device for controlling the display of the touch panel. Such a program is recorded in a computer-readable recording medium such as a flexible disk, CD-ROM (Compact Disk-Read Only Memory), ROM, RAM, and memory card which are provided in the computer, and can be provided as a program product. In addition, the program may be provided such that the program is recorded in a recording medium such as a hard disk incorporated in the computer. In addition, the program may be provided by downloading using the network.

In addition, the program according to the present invention may execute the process by bringing up necessary modules in predetermined arrangement and at predetermined timing, from among program modules provided as one part of an operating system (OS) of the computer. In this case, the program itself does not contain the above modules and the process is executed in cooperation with the OS. The program not containing the modules is also included in the program according to the present invention.

In addition, the program according to the present invention may be provided such that the program is incorporated in a part of another program. In this case also, the program itself does not contain the above modules and the process is executed in cooperation with the other program. The program incorporated in the other program is also included in the program according to the present invention.

The provided program product is installed in a program storage unit such as a hard disk and executed. In addition, the program product includes the program itself, and the recording medium in which the program is recorded.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A display system comprising:
an information processing device including a first storage device for storing electronic information; and
a display device having a second storage device and a touch panel, wherein
said information processing device and said display device are connected through a network, and
said display device includes
a temporary storage module for accessing said information processing device, reading a predetermined amount of electronic information from said electronic information stored in said first storage device, and temporarily storing said predetermined amount of electronic information in said second storage device,
a storage module for storing a display screen created from said predetermined amount of electronic information stored temporarily,
a detecting module for detecting a fact that a scroll operation for a display of said touch panel is performed on said touch panel,
a scroll processing module for moving a display range displayed in said touch panel in said display screen, in a scroll direction instructed by said scroll operation and displaying said display range in said touch panel, in a case where said display range does not reach an end of said display screen even after moved in said scroll direction, and
an update processing module for accessing said information processing device, reading the predetermined amount of electronic information provided next in said scroll direction from said first storage device, storing said next predetermined amount of electronic information in said second storage device, and updating the display of said touch panel to a display screen created from said next predetermined amount of electronic information in a case where said display range reaches the end of said display screen after moved in said scroll direction, and in a case where an operation amount of said scroll operation is more than or equal to a threshold value.

2. A display device for controlling a display of a display device having a touch panel,
said display device comprising:
a temporary storage module for reading a predetermined amount of electronic information from electronic information stored in a first storage device, and temporarily storing said predetermined amount of electronic information in a second storage device;
a storage module for storing a display screen created from said predetermined amount of electronic information;
a detecting module for detecting a fact that a scroll operation for a display of said touch panel is performed on said touch panel;
a scroll processing module for moving a display range displayed in said touch panel in said display screen, in a scroll direction instructed by said scroll operation and displaying said display range in said touch panel, in a case where said display range does not reach an end of said display screen even after moved in said scroll direction; and
an update processing module for reading the predetermined amount of electronic information provided next in said scroll direction from said first storage device, storing said next predetermined amount of electronic information in said second storage device, and updating the display of said touch panel to a display screen created from said next predetermined amount of electronic information, in a case where said display range reaches the end of said display screen after moved in said scroll direction, and in a case where an operation amount of said scroll operation is more than or equal to a threshold value.

3. The display device according to claim 2, further comprising:
a deformation processing module for deforming the display while maintaining display contents of said touch panel without updating the display of said touch panel in a case where said display range reaches the end of said display screen after moved in said scroll direction by said predetermined amount, and in a case where the operation amount of said scroll operation does not exceed said threshold value.

4. The display device according to claim 2, wherein
said update processing module updates the display of said touch panel after said display range is set to a range having the end of said display screen as a tip end in said scroll direction, and an image in the range is deformed in said scroll direction by an amount corresponding to said operation amount.

5. The display device according to claim 2, wherein
said update processing module updates said threshold value according to the number of times to read the same electronic information from said first storage device.

6. The display device according to claim 5, wherein
said update processing module reduces said threshold value as the number of times to read the same electronic information from said first storage device is increased.

7. The display device according to claim 2, wherein
said update processing module updates said threshold value according to a time required for reading said predetermined amount of electronic information from said first storage device.

8. The display device according to claim 7, wherein
said update processing module reduces said threshold value as the time required for reading said predetermined amount of electronic information from said first storage device is decreased.

9. An image forming device comprising:
the display device according to claim 2.

10. A non-transitory computer-readable storage medium storing a display control program for causing a computer execute a process to control a display in a touch panel in a display screen created based on electronic information, wherein
said display control program causes said computer execute the steps of:
reading a predetermined amount of electronic information from electronic information stored in a first storage device, and temporarily storing said predetermined amount of electronic information in a second storage device;
storing the display screen created from said predetermined amount of electronic information;
specifying a display range corresponding to said touch panel in said display screen, and displaying said display range in said touch panel;
detecting a fact that a scroll operation for a display of said touch panel is performed on said touch panel;
determining whether or not the display range displayed in said touch panel in said display screen reaches an end of said display screen after moved in a scroll direction indicated by said scroll operation;
moving said display range in said scroll direction and displaying said display range in said touch panel, in a case where said display range does not reach the end of said display screen after moved in said scroll direction; and
reading the predetermined amount of electronic information provided next in said scroll direction from said first storage device, temporarily storing said next predetermined amount of electronic information in said second storage device, and updating the display of said touch panel to a display screen created from said next predetermined amount of electronic information, in a case where said display range reaches the end of said display screen after moved in said scroll direction, and in a case where an operation amount of said scroll operation is more than or equal to a threshold value.
